(19) United States
(12) Patent Application Publication
(10) Pub. No.: US 2024/0060359 A1
(43) Pub. Date: Feb. 22, 2024

(54) TEARABLE CURTAIN SYSTEM

(71) Applicant: Ted J. Fechser, Las Vegas, NV (US)

(72) Inventor: Ted J. Fechser, Las Vegas, NV (US)

(21) Appl. No.: 17/891,718

(22) Filed: Aug. 19, 2022

(51) Int. Cl. E06B 9/17; E06B 9/13

(52) U.S. Cl. CPC E06B 9/1703; E06B 9/13; E06B 9/17046

(57) ABSTRACT

A system can comprise a first anchor comprising a first fastening system configured to couple the first anchor to a doorframe; a second anchor comprising a second fastening system configured to couple the second anchor to at least one of the doorframe at a lower portion than the first anchor or a floor to which the doorframe is coupled; and/or a tearable material coupled to and spanning between the first anchor and the second anchor. The tearable material can comprise a plurality of perforations configured to cause the tearable material to tear, while the first anchor and the second anchor remain in place, in response to a user contacting the tearable material.

### FIELD

The present disclosure generally relates to decorations, for example, for a special occasion, event, or get together, and more specifically, to a tearable curtain system.

### BACKGROUND

During a special occasion or event, for example, there may be one or more attendees or guests toward whom the event may be focused. To add excitement to the event or emphasis toward such an attendee, the attendee may enter the room or venue of the event in a conspicuous manner. Devices and systems are desired for allowing such conspicuous entrances.

### SUMMARY

This summary is provided to introduce a selection of concepts in a simplified form. These concepts are described in further detail in the detailed description of examples of the disclosure below. This summary is not intended to necessarily identify key features or essential features of the disclosed subject matter, nor is it intended to be used to limit the scope of the claimed subject matter.

In various examples, a tearable curtain system can comprise a first anchor comprising a first fastening system configured to couple the first anchor to a doorframe; a second anchor comprising a second fastening system configured to couple the second anchor to at least one of the doorframe at a lower portion than the first anchor or a floor to which the doorframe is coupled; and/or a tearable material coupled to and spanning between the first anchor and the second anchor. The tearable material can comprise a plurality of perforations configured to cause the tearable material to tear, while the first anchor and the second anchor remain in place, in response to a user contacting the tearable material.

In various examples, the first anchor can comprise a first anchor first side and a first anchor second side, and a first anchor body spanning therebetween. The second anchor can comprise a second anchor first side and a second anchor second side, and a second anchor body spanning therebetween. In various examples, each of the first fastening system and the second fastening system can comprise an adhesive material. In various examples, the first fastening system can comprise the adhesive material disposed on each of the first anchor first side and the first anchor second side. In various examples, the first fastening system can comprise the adhesive material disposed on the first anchor body configured to couple the first anchor to an upper portion or head of the doorframe. In various examples, the second fastening system can comprise the adhesive material disposed on each of the second anchor first side and the second anchor second side. In various examples, the second fastening system can comprise the adhesive material disposed on the second anchor body configured to couple the second anchor to the floor.

In various examples, the perforations of the plurality of perforations can be disposed in a plurality of perforation lines within a perforated portion of the tearable material. In various examples, each perforation line can comprise at least one smaller perforation and at least one larger perforation. The at least one smaller perforation can comprise a first length that is smaller than a second length of the at least one larger perforation. In various examples, each perforation line of the plurality of perforation lines spans in a first direction, along which at least one perforation in each perforation line spans, and wherein, along a second direction that is different than the first direction, a smaller perforation of a first perforation line is aligned with a larger perforation of a second perforation line. The first direction can span between the first anchor and the second anchor. The second direction can span substantially perpendicular to the first direction. In various examples, the perforated portion can extend to or within four inches from the side edges of the tearable material.

In various examples, the first anchor body can be about thirty-six inches in length between the first anchor first side and the first anchor second side. In various examples, the first anchor body can comprise a first anchor shell and a cavity disposed therein, wherein a roll is disposed within the cavity, wherein the tearable material is coupled to and unrolled from the roll, wherein the first anchor shell comprises a void through which the tearable material is disposed and unrolled from the roll. In various examples, the roll can be configured to be removed from the first anchor shell after usage of the tearable material.

In various examples, a total length of the system with the tearable material fully extended within the doorframe is about eighty inches. In various examples, side edges of the tearable material are each disposed within six inches of sides of the doorframe. In various examples, the tearable material, in response to the first anchor being coupled to the doorframe and the second anchor being coupled to at least one of the lower portion of the doorframe or the floor, can be taut between the first anchor and the second anchor.

For the purpose of summarizing the disclosure and the advantages achieved over the prior art, certain objects and advantages of the disclosure have been described herein. Of course, it is to be understood that not necessarily all such objects or advantages can be achieved in accordance with any particular example of the disclosure. Thus, for example, those skilled in the art will recognize that the examples disclosed herein can be carried out in a manner that achieves or optimizes one advantage or group of advantages as taught or suggested herein without necessarily achieving other objects or advantages as can be taught or suggested herein.

All of these examples are intended to be within the scope of the disclosure. These and other examples will become readily apparent to those skilled in the art from the following detailed description of certain examples having reference to the attached figures, the disclosure not being limited to any particular example(s) discussed.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures. Elements with like element numbering throughout the figures are intended to be the same.

FIG. 1 depicts a tearable curtain system disposed in a doorframe, in accordance with various examples.

FIG. 2 depicts a cross-sectional perspective view of a tearable curtain system, in accordance with various examples.

FIG. 3 depicts a schematic diagram of a tearable curtain system, in accordance with various examples.

### DETAILED DESCRIPTION

The detailed description of various examples herein makes reference to the accompanying drawings, which show the examples by way of illustration. While these examples are described in sufficient detail to enable those skilled in the art to practice the disclosure, it should be understood that other examples may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural examples, and any reference to more than one component or step may include a singular component or step. Also, any reference to attached, fixed, connected or the like may include permanent, fixed, removable, temporary, partial, full and/or any other possible attachment option.

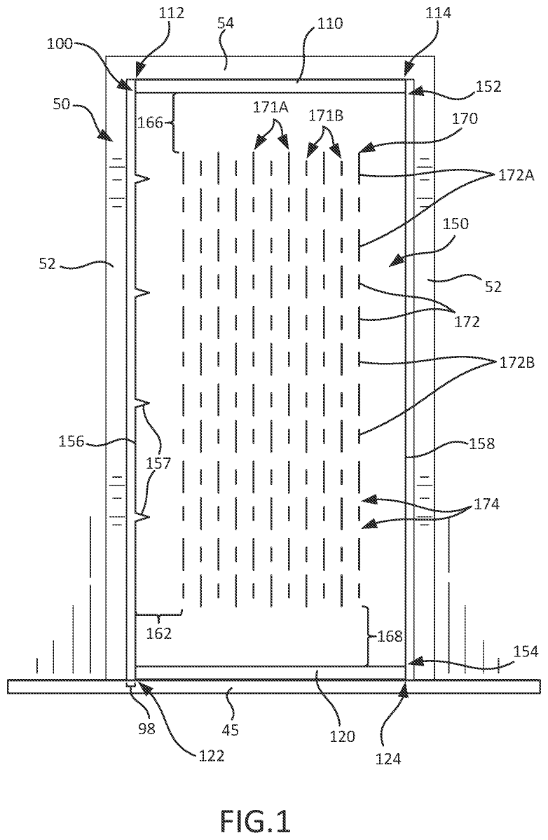

With reference to FIG. 1, a tearable curtain system 100 can be comprised or disposed in a doorframe 50, in accordance with various examples. In various examples, a doorframe 50 can comprise a doorframe head 54 (i.e., an upper portion at the top), a doorframe sill (i.e., at the bottom), and/or door jambs 52. In various examples, a doorframe may not comprise a doorframe sill, such that the doorway defined by the doorframe is defined at the bottom by the floor or ground to which the doorframe is coupled (e.g., door jambs 52 are coupled to floor 45, shown in FIG. 1).

In various examples, a tearable curtain system can comprise a first anchor, a second anchor, and tearable material coupled to and spanning between the first anchor and second anchor. The first anchor can be configured to be disposed higher in a door frame than the second anchor. In various examples, the first anchor can be configured to couple to an upper portion of a doorframe (e.g., the doorframe head, or the upper portion of a door jamb(s) (e.g., spanning between the door jambs), such as within the top half, third, quarter, fifth, etc. of a doorframe). The second anchor can be configured to couple to a lower portion of a door frame (e.g., the doorframe sill, the floor or ground to which the doorframe is coupled, a lower portion of at least one door jamb (e.g., between the door jambs), such as within the lower half, third quarter, fifth, etc. of a door frame, and/or the like). For example, system 100 can comprise a first anchor 110 coupled to doorframe head 54 and/or at least one door jamb 52, and a second anchor 120 coupled to floor 45 and/or at least one door jamb 52.

In various examples, the first anchor and the second anchor in a tearable curtain system can be coupled to the doorframe in any suitable manner. Each of the first anchor and the second anchor can comprise a fastening system configured to couple the respective anchor to and/or within the doorframe. For example, the fastening system for a first anchor can comprise components configured to couple the first anchor to the doorframe head and/or at least one door frame jamb. Similarly, the fastening system for a second anchor can comprise components configured to couple the second anchor to the doorframe sill, the floor or ground, and/or at least one door frame jamb.

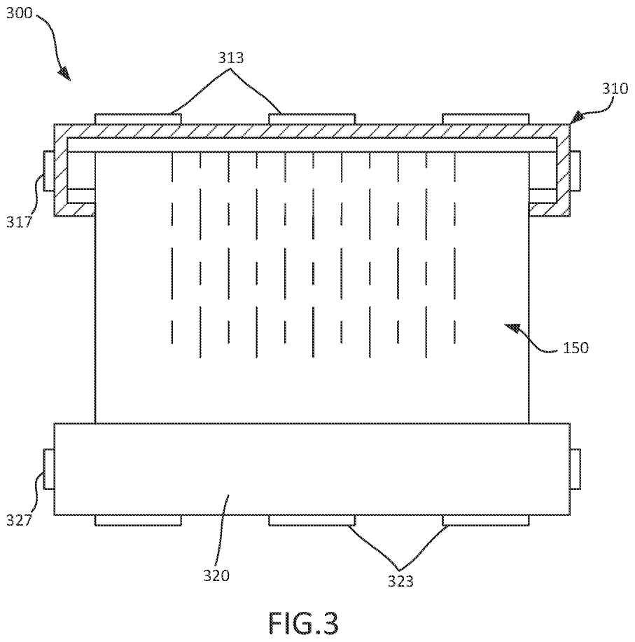

With additional reference to tearable curtain system 300 depicted in FIG. 3, the fastening system of first anchor 310 (an example of first anchor 110 in FIG. 1) can comprise head fasteners 313 (configured to couple first anchor 310 to a doorframe head) and/or jamb fasteners 317 (configured to couple first anchor 310 to a doorframe jamb). Head fasteners 313 can be coupled to a top portion of first anchor 310 (e.g., a portion of a first anchor body facing upward when installed in a doorframe). Jamb fasteners 317 can be coupled to a side portion of first anchor 310 (e.g., a portion facing to the side when installed in a doorframe, such as first anchor first side 112 and/or first anchor second side 114 in FIG. 1). The fastening system of second anchor 320 (an example of second anchor 120 in FIG. 1) can comprise ground fasteners 323 (configured to couple second anchor 320 to a doorframe sill or the ground or floor) and/or jamb fasteners 327 (configured to couple second anchor 320 to a doorframe jamb). Ground fasteners 323 can be coupled to a bottom portion of second anchor 320 (e.g., a portion of a second anchor body facing downward when installed in a doorframe). Jamb fasteners 327 can be coupled to a side portion of second anchor 320 (e.g., a portion facing to the side when installed in a doorframe, such as second anchor first side 122 and/or second anchor second side 124 in FIG. 1). There can be any suitable number of fasteners in an anchor's fastening system. For example, first anchor 310 can comprise three head fasteners 313, and second anchor 320 can comprise three ground fasteners 323 (one fastener proximate to each side of the respective anchor, and one in a middle portion of the respective anchor body). As another example, first anchor 310 and/or second anchor 320 can comprise at least one jamb fastener 317 and 327, respectively, on each side portion of the respective anchor.

Fasteners can comprise any suitable device to couple the respective anchor to the doorframe and/or ground or floor, such as an adhesive, hooks, screws, hook and loop fasteners, clamps, prongs, brackets, and/or the like. In various examples, an anchor can be coupled to a doorframe by tight fit or another force (e.g., between the door jambs). For example, the anchor can comprise a spring force with an outward bias (e.g., toward the side portions of the anchor), such that the anchor can be compressed (toward the middle of the anchor) and then placed between the door jambs. The outward spring force of the anchor can be applied to the door jambs, coupling the anchor to the doorframe and holding the anchor in place.

To couple the first anchor to the door frame, in various examples, a head fastener can be coupled to the doorframe head, and/or a jamb fastener can be coupled to a door jamb. To couple the second anchor to the door frame, in various examples, a ground fastener can be coupled to the doorframe sill, the ground, or the floor, and/or a jamb fastener can be coupled to a door jamb. The anchor fastening systems are configured to securely couple the respective anchor within the doorframe and/or doorway to prevent or mitigate the risk of moving the respectively anchor in response to a user of the tearable curtain system contacting the tearable material (e.g., to run through the tearable material).

In various examples, the first and second anchors can comprise any suitable structure. For example, the first and/or second anchor can comprise an object (e.g., a non-hollow object or block, or an object, or objects coupled together, without further components of operational purpose) to which the tearable material is coupled. The tearable material can be adhered to the respective anchor, coupled to the respective anchor by a portion of the tearable material being disposed within a channel or cutout within the respective anchor, wrapped at least partially around the respective anchor, and/or the like to couple the tearable material to the anchor.

As another example, the first and/or second anchor can comprise a roll, and the tearable material can be coupled to the roll. The tearable material can be rolled around the roll, and therefore, unrolled from the roll to increase the amount of tearable material disposed away from the respective anchor and between the first and second anchors. For storage, or to increase the amount of tearable material disposed around the roll, the tearable material can be rolled around the roll. In various examples, the first and/or second anchor can comprise an anchor shell at least partially enclosing a cavity therein. The roll and/or the tearable material in a rolled configuration can be disposed at least partially in the cavity. The cavity can have a dimension(s) complementary to those of the roll and/or the tearable material in a rolled configuration. For example, the cross-sectional length and/or width of the anchor shell and/or cavity therein can be complementary to a cross-sectional dimension of the roll and/or tearable material in a rolled configuration (e.g., a diameter thereof). The anchor shell can comprise any suitable cross-sectional shape, such as square, rectangular, triangular, hexagonal, octagonal, oval, circular, and/or the like. The anchor shell can comprise a void disposed at least partially along a length thereof through which the tearable material can be disposed and rolled or unrolled from the roll. The void in the anchor shell can comprise a length or other dimension that is complementary to a dimension of the tearable material (e.g., the width and/or thickness of the tearable material). The tearable material can be coupled to the roll and/or anchor shell to allow an upper portion of the tearable material to remain coupled to the respective anchor in response to at least a portion of the tearable material being unrolled. For example, an end portion of the tearable material can be adhered to the roll, coupled to the roll via a channel or cutout in the roll, in which the tearable material is coupled (e.g., by tight fit, clamping force, or any other suitable coupling method), and/or the like to couple the tearable material to the roll. As another example, the tearable material can comprise a stop that has a dimension larger than the void in the anchor shell, such that in response to a length of the tearable material being unrolled from the roll, the stop coupled to the tearable material can prevent further tearable material from being disposed outside the anchor shell.

In various examples, the roll within an anchor shell can be removed (e.g., after the tearable material has been torn during use). The removed roll can be replaced by a new roll comprising unused and/or untorn tearable material by disposing the new roll into the anchor shell. The tearable material can be coupled to the other anchor, if applicable, in any suitable manner, such as those discussed herein. In various examples, after use of the tearable material, the used portion can be removed, and additional tearable material can be unrolled from the respective anchor and coupled to the other anchor, thus allowing reuse of the anchors. The tearable material can comprise a perforated line spanning between side edges 156 to facilitate removal or separation of the used portion from the rest of the tearable material (e.g., the tearable material still in a rolled configuration). In various examples, the tearable curtain system can be a single-use item.

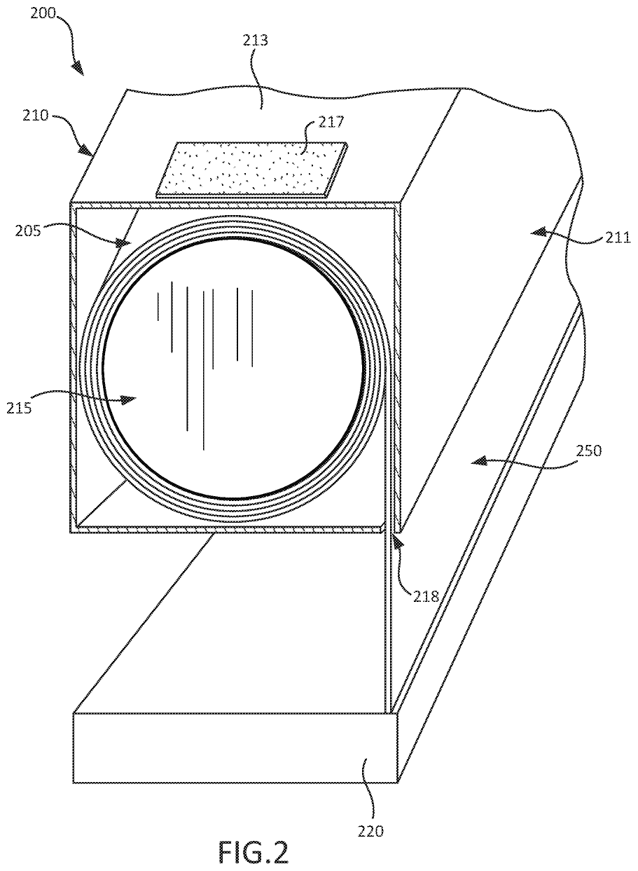

In various examples, a tearable curtain system can comprise anchors having the same or different structures. For example, a tearable curtain system can comprise first and second anchors both comprising a roll about which the tearable material can be rolled or unrolled (e.g., resembling a scroll). As another example, a tearable curtain system can comprise first and second anchors each comprising an object to which the tearable material are coupled. As another example, a tearable curtain system can comprise a first anchor having a different structure than the second anchor. For example, with reference to FIG. 2, second anchor 220 (an example of second anchor 120 in FIG. 1) of tearable curtain system 200 can comprise an object coupled to tearable material 250. First anchor 210 can comprise anchor shell 211. Anchor shell 211 can couple to an upper portion of a doorframe, for example, by head fastener 217 disposed on top portion 213 of first anchor 210 coupling to a doorframe head. Anchor shell 211 can at least partially enclose a cavity therein. Roll 215 can be comprised within the cavity of anchor shell 211. Tearable material 250 can be rolled around roll 215 in a rolled configuration 205. Tearable material 250 can be unrolled by pulling first anchor 210 and/or second anchor 220 away from the other, and tearable material 250 can be unrolled from roll 215 and exit anchor shell 211 through void 218. Void 218 can have a length that is complementary to a width of tearable material 250 and/or a thickness that is complementary to a thickness of tearable material 250. The void in an anchor shell can be disposed in any suitable position on an anchor shell (e.g., near a corner of anchor shell 211 having a square or rectangular cross-sectional shape, near a center of a lower portion of an anchor shell, and/or the like).

In various examples, the tearable material of a tearable curtain system can be coupled to the first anchor and second anchor. The tearable material can span between the first anchor and second anchor. In response to the tearable curtain system being installed or disposed in a doorframe or doorway, the tearable material can be taut or have minimal slack between the first anchor and second anchor.

In various examples, the tearable material can comprise single, solid, integral, and/or monolithic piece of material. In various examples, the tearable material can comprise a perforated portion (e.g., within the single piece of material). The perforated portion can comprise a plurality of perforations (i.e., voids or apertures disposed through the tearable material in some arrangement). The perforated portion can extend any suitable length between the top portion (e.g., the portion of the tearable material disposed in the doorway that is proximate or most proximate the doorframe head) and bottom portion (e.g., the portion of the tearable material disposed in the doorway that is proximate or most proximate the doorframe sill or floor/ground), and between the side edges (e.g., the edges of the tearable material disposed in the doorway that is proximate or most proximate the door jambs), of the tearable material. In various examples, the perforated portion of the tearable material can extend to or within four inches or six inches from the side edges of the tearable material. There can be a solid margin (i.e., without perforations) between the perforated portion and the side edge(s) of the tearable material. For example, with reference to FIG. 1, perforated portion 170 of tearable material 150 can extend between side edges 156 and 158 to within four or six inches thereof. That is, side margin 162 between perforated portion 170 and side edge 156 can be four or six inches or less. In various examples, the perforated portion of the tearable material can extend completely between the first and second anchors when installed in a doorframe, or to or within four inches or six inches from the first and second anchors when installed in a doorframe. For example, with reference to FIG. 1, perforated portion 170 of tearable material 150 can extend to first anchor 110 and/or second anchor 120, and/or to within four or six inches thereof. That is, there may be no margin between the perforated portion and the first and second anchors, or a top margin 166 and/or a bottom margin 168 between perforated portion 170 and first anchor 110 and second anchor 120, respectively, can be four or six inches or less. In various examples, the margin between the perforated portion and the first anchor can be larger than a margin between the perforated portion and the second anchor. In various examples, there can be a margin between the perforated portion and the first anchor, but no margin between the perforated portion and the second anchor.

In various examples, with reference to FIG. 1, the plurality of perforations in the perforated portion of the tearable material can be disposed in a plurality of perforation lines (e.g., perforation lines 171A and 171B). The perforation lines can span in any suitable direction. For example, the perforation lines can span in a direction between the first and second anchors. The direction in which the perforation lines span can be deemed a first direction. The first direction can span directly between the first and second anchors (e.g., a direction parallel to the door jambs of a doorframe, or the direction of a gravitational pull). In various examples, the first direction can span at some angle between the first and second anchors, such as at about 45 degrees from the direct path between the first and second anchors (wherein “about” in this context means plus or minus 20 degrees).

Each perforation line can comprise a plurality of perforations therein (e.g., perforations 172). The perforations in each perforation line can comprise any suitable size, combination, pattern, and/or arrangement. In various examples, each perforation in a perforation line can comprise the same dimensions and be uniform with one another (i.e., each perforation can have the same length, width, cross-sectional length such as circumference, and/or the like). In various examples, the perforations within a perforation line can be evenly spaced. In various examples, the perforations within a perforation line can comprise varying dimensions and/or spacing.

In various examples, the perforation lines within the perforated portion of the tearable material can be uniformly spaced between the side edges of the tearable material. In various examples, the perforation lines within the perforated portion of the tearable material can having varying spaces therebetween. In various examples, the perforation lines within the perforated portion of the tearable material can have the same perforation pattern and/or arrangement, but the perforations therein can be staggered in a second direction. The second direction can be substantially perpendicular to the first direction, described herein (wherein “substantially” in this context means plus or minus 20 degrees). The spaces between perforations in a perforation line can be referred to as solid portions in the tearable material. Therefore, in a staggered arrangement, the perforations of one perforation line can be at least partially aligned with the solid portions of an adjacent line as viewed in the second direction. In another example of a staggered arrangement, perforation lines can have perforations of alternating dimensions (e.g., alternating larger and smaller perforations along the length of the perforation line). The staggered arrangement can be such that the larger perforations in a first perforation line are aligned with the smaller perforations in a second perforation line (which can be adjacent to the first perforation line), and the smaller perforations in the first perforation line are aligned with the larger perforations in the second perforation line, when viewed in the second direction. For example, perforated portion 170 in tearable material 150 can comprise first perforation lines 171A and second perforation lines 171B. Each perforation line comprises alternating larger perforations 172A and smaller perforations 172B along the length of the respective perforation line. The larger perforations 172A of first perforation lines 171A are aligned with the smaller perforations 172B of second perforation lines 171B, and the smaller perforations 172B of first perforation lines 171A are aligned with the larger perforations 172A of second perforation lines 171B, when viewed in a second direction (the direction substantially perpendicular to the direction in which perforation lines 171A,B span).

In various examples, at least a portion of one perforation in a first perforation line can be aligned with at least a portion of a solid portion of second perforation line. For example, a portion of larger perforations 172A in first perforation lines 171A are aligned with a portion of solid portions 174 in second perforation lines 171B, and a portion of larger perforations 172A in second perforation lines 171B are aligned with a portion of solid portions 174 in first perforation lines 171A.

In various examples, the perforation lines within the perforated portion of the tearable material can comprise first perforation lines having a first perforation pattern and second perforation lines having a second perforation pattern. The first and second perforation patterns can be different. First perforation lines and second perforation lines can alternate in order between the side edges of the tearable material. For example, first perforation lines 171A and second perforation lines 171B can be considered to have different perforation patterns, or the same perforation patters in a staggered configuration.

The tearable curtain systems disclosed herein are configured to be disposed in a doorway and allow a user to run through the tearable material (e.g., to make an emphasized entrance into a room). Accordingly, the arrangements of perforations discussed herein, including the arrangements and patterns of perforations and perforation lines (e.g., that depicted in FIG. 1), are configured to allow and facilitate the tearing of the tearable material at and around the point at which the user impacts the tearable material. That is, the patterns and arrangements of perforations discussed herein on the tearable material sufficiently weaken the tearable material in the perforated portion to allow the perforated portion and/or tearable material to give way and tear in response to a user running through the tearable material (e.g., rather than the tearable material maintaining enough strength to cause the first or second anchors to become decoupled from the respective positions in the doorway in response to impact by the user with the tearable material). That is, the strength of the tearable material in the tearable portion may be less than the strength of the coupling of the first and/or second anchors to and/or within the doorframe, such that the tearable material gives way before and/or rather than the coupling of the first and/or second anchors in response to an impact to the tearable material. Also, such perforation patterns and arrangements can facilitate multiple points of tearing in the tearable material, which can be concentrated at the point of impact of the user running through the tearable material. Thus, the visual effect can include more tears and projection of the torn tearable material than configurations without such perforations (configurations without the perforations disclosed herein may simply cause the material impacted to move to the side, up, or down, rather than have a tearing effect and presenting the associated visual).

To further weaken the tearable material and facilitate the tearing effect discussed above, in various examples, the tearable material can comprise side cutouts (e.g., side cutouts 157). Side cutouts 157 can be voids cut into side edges 156, 158 of tearable material 150 toward the opposite side edge to further weaken the tearable material. The position of side cutouts 157 can be at any suitable position and/or in any suitable arrangement. For example, side cutouts 157 can be disposed equidistant from one another on a side edge 156, and aligned with perforated portion 170 along the second direction. That way, tearable material 150 is further weakened in line with perforated portion 170, so a tearing resulting from a user running through tearable material 150 will occur within the length of perforated portion 170 between first anchor 110 and second anchor 120 (e.g., avoiding decoupling of the first and/or second anchors from their respective positions in the doorway).

In various examples, the total length (or height when installed within a doorway) of a tearable curtain system can be complementary to the length and/or height of a doorway in a doorframe. In the United States of America, for example, a standard door can have a length (height) of about 80 inches (“about” meaning plus or minus 16 inches in this context) and a width of about 36 inches (“about” meaning plus or minus 6 inches in this context). Therefore, in various examples, the total length or height of a tearable curtain system can be about 80 inches (e.g., with the tearable material fully extended between the first and second anchors) and the width thereof can be about 36 inches. In various examples, a width of the first anchor body and/or the second anchor body, and/or the tearable material, can be about 36 inches. Having dimensions complementary to a desired doorway and/or doorframe can allow the tearable material in the tearable curtain system to be pulled taut when the first anchor is installed proximate or coupled to the upper portion of the doorframe (e.g., at the doorframe head) and the second anchor is installed proximate or coupled to the lower portion of the doorframe (e.g., at the doorframe sill or the ground/floor).

In various examples, the total length or height of a tearable curtain system can be less than the height of the door, such that only a portion of the doorway is covered by the tearable curtain system when installed. For example, if the user of the system (i.e., the person who will impact the tearable material) is a child, then only a portion of the respective doorway may be covered to have the desired effect (e.g., a lower half, the lower two-thirds, the lower three-fourths, etc.). Accordingly, any suitable length/height of a tearable curtain system can be implemented.

In various examples, the tearable material can comprise a width that is less than the width of the first anchor and/or second anchor. For example, in examples in which the tearable material is rolled into an anchor shell of the first and/or second anchor, the tearable material can comprise a width that is less than the anchor shell(s) into which the tearable material will roll, allowing dispensing, retracting, and storing of the tearable material in the anchor shell. In such examples, with reference to FIG. 1, there can be a gap 98 between side edges 156 and 158 of tearable material 150 and door jambs 150. Gaps 98 can allow tearable material 150 to easily be moved and fit in the doorway of doorframe 50. A gap 98 can be less than one inch, one to three inches, or less than six inches.

In various examples, the tearable material can be made of and/or comprise any suitable material, such as a paper material, a polymeric material, a textile or fabric material, and/or the like. In various examples, the first anchor and/or second anchor can be made of and/or comprise any suitable material, such as a paper material (e.g., cardboard), a polymeric material, a metallic material, a rubber material, a foam material, a textile or fabric material, and/or the like. In various examples, the first and/or second anchor can comprise a flexible and/or cushion material configured to soften or lessen an impact with the respective anchor, such as a rubber material, a foam, a soft polymer material and/or the like. In various examples, the first and/or second anchor can be wrapped in such a flexible and/or cushion material.

In various examples, the tearable curtain systems discussed herein allow for easy installment within a doorframe and facilitate tearing of the tearable material in a way that avoids separation of the tearable material from the first or second anchors and/or separation of the first or second anchors from their positions coupled in the doorframe. Thus, the person entering a room (i.e., tearing through the tearable material) can make the emphasized entrance desired, having multiple points of tearing in the tearable material facilitated by the perforation patterns and arrangements discussed herein, and/or avoiding pieces of the tearable curtain system becoming decoupled from their installed positions in the doorframe.

Without departing from the scope and spirit of the present invention, reasonable features, modifications, advantages, and design variations of the claimed invention will become readily apparent to those skilled in the art by following the guidelines set forth in the preceding detailed description and examples.

It is understood that although a number of different examples of the tearable curtain system described herein has been illustrated and described herein, one or more features of any one example can be combined with one or more features of one or more of the other examples, provided that such combination satisfies the intent of the present disclosure.

While a number of exemplary aspects and examples of the tearable curtain system have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

Systems and methods are discussed herein. In the detailed description herein, references to “various examples”, “one example”, “an example”, “an example embodiment”, etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. After reading the description, it will be apparent to one skilled in the relevant art(s) how to implement the disclosure in alternative examples.

Benefits, other advantages, and solutions to problems have been described herein with regard to specific examples. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an example, B alone may be present in an example, C alone may be present in an example, or that any combination of the elements A, B and C may be present in a single example; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various examples that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system, comprising:
a first anchor comprising a first fastening system configured to couple the first anchor to a doorframe;
a second anchor comprising a second fastening system configured to couple the second anchor to at least one of the doorframe at a lower portion than the first anchor or a floor to which the doorframe is coupled; and
a tearable material coupled to and spanning between the first anchor and the second anchor, wherein the tearable material comprises a plurality of perforations configured to cause the tearable material to tear, while the first anchor and the second anchor remain in place, in response to a user contacting the tearable material.

2. The system of claim 1, wherein the first anchor comprises a first anchor first side and a first anchor second side, and a first anchor body spanning therebetween, and wherein the second anchor comprises a second anchor first side and a second anchor second side, and a second anchor body spanning therebetween.

3. The system of claim 2, wherein each of the first fastening system and the second fastening system comprises an adhesive material.

4. The system of claim 3, wherein the first fastening system comprises the adhesive material disposed on each of the first anchor first side and the first anchor second side.

5. The system of claim 3, wherein the first fastening system comprises the adhesive material disposed on the first anchor body configured to couple the first anchor to an upper portion of the doorframe.

6. The system of claim 3, wherein the second fastening system comprises the adhesive material disposed on each of the second anchor first side and the second anchor second side.

7. The system of claim 3, wherein the second fastening system comprises the adhesive material disposed on the second anchor body configured to couple the second anchor to the floor.

8. The system of claim 1, wherein the perforations of the plurality of perforations are disposed in a plurality of perforation lines within a perforated portion of the tearable material.

9. The system of claim 8, wherein each perforation line comprises at least one smaller perforation and at least one larger perforation, wherein the at least one smaller perforation comprises a first length that is smaller than a second length of the at least one larger perforation.

10. The system of claim 9, wherein each perforation line of the plurality of perforation lines spans in a first direction, along which at least one perforation in each perforation line spans, and wherein, along a second direction that is different than the first direction, a smaller perforation of a first perforation line is at least partially aligned with a larger perforation of a second perforation line.

11. The system of claim 10, wherein the first direction spans between the first anchor and the second anchor.

12. The system of claim 10, wherein the second direction spans substantially perpendicular to the first direction.

13. The system of claim 8, wherein the perforated portion extends to or within four inches from the side edges of the tearable material.

14. The system of claim 2, wherein the first anchor body is about thirty-six inches in length between the first anchor first side and the first anchor second side.

15. The system of claim 2, wherein the first anchor body comprises a first anchor shell and a cavity disposed therein, wherein a roll is disposed within the cavity, wherein the tearable material is coupled to and unrolled from the roll, wherein the first anchor shell comprises a void through which the tearable material is disposed and unrolled from the roll.

16. The system of claim 15, wherein the roll is configured to be removed from the first anchor shell after usage of the tearable material.

17. The system of claim 2, wherein a total length of the system with the tearable material fully extended within the doorframe is about eighty inches.

18. The system of claim 1, wherein side edges of the tearable material are each disposed within six inches of sides of the doorframe.

19. The system of claim 1, wherein the tearable material, in response to the first anchor being coupled to the doorframe and the second anchor being coupled to at least one of the lower portion of the doorframe or the floor, is taut between the first anchor and the second anchor.
